(19) United States
(12) Patent Application Publication
(10) Pub. No.: US 2008/0006662 A1
(43) Pub. Date: Jan. 10, 2008

(54) CARRIER FOR LOADS, IN PARTICULAR BICYCLES

(75) Inventors: Harald Bergerhoff, Hamburg (DE); Michael Waller, Hamburg (DE); Gerald Hahn, Wistedt (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/771,063

(22) Filed: Jun. 29, 2007

(30) Foreign Application Priority Data
Jul. 8, 2006 (DE) 10 2006 031 694.0

(51) Int. Cl. B60R 9/10

(52) U.S. Cl. 224/400

(57) ABSTRACT

A bicycle carrier includes a base holder mountable to a vehicle, a support holder for holding a bicycle, and a fixing device. The base holder includes first and second guide rails. The support holder includes first and second support rails. The support rails movably engage with the guide rails such that the support holder is movable between a neutral position in which the support holder extends over the base holder and an operating position in which the support holder extends from the base holder. The fixing device can act on the first rails to disrupt the movable engagement between these rails. The fixing device is actuatable between an unlocked position in which the first rails are movable relative to one another and a locked position in which the first rails are locked in place while the support holder is in the operating position to lock the support holder in place.

### CROSS-REFERENCE TO RELATED APPLICATIONS

This application claims foreign priority benefits under 35 U.S.C. § 119(a)-(d) to DE 10 2006 031 694.0, filed Jul. 8, 2006, which is hereby incorporated by reference in its entirety.

### BACKGROUND OF THE INVENTION

1. Field of the Invention

The present invention relates to a bicycle carrier for use with a motor vehicle.

2. Background Art

DE 102 31 963 B4 describes a load carrier having a load support displaceably supported relative to a vehicle by a track system. A component of the load support is a fixing device by which the load support may be fixed in either a retracted neutral position or an extended operating position relative to the vehicle.

DE 44 41 853 A1 describes a vehicle having a rear bumper which is movable between an extended position and a neutral position by connected profile rods. The bumper and profile rods serve as a support device for transported articles such as bicycles.

DE 203 16 591 U1 describes a vehicle having a telescopically extendable bumper for holding bicycles. The bumper has cantilever beams by which the bumper may be adjusted in end, neutral, and operating positions. A spreading device is between a vehicle frame oriented transverse to the longitudinal direction of the vehicle. The spreading device is elastically pre-tensioned in the direction of extension of the bumper. After a locking device is released, the spreading device automatically extends into the end position for holding bicycles.

### SUMMARY OF THE INVENTION

An object of the present invention includes a bicycle carrier for use with a vehicle in which the bicycle carrier includes a support holder for holding a bicycle in which the support holder is movable relative to the rear end of the vehicle between a neutral position in which the support holder is pushed into a body structure of the rear end of the vehicle and an operating position in which the support holder extends from the rear end of the vehicle to hold the bicycles with the support holder being fixed in place at least in the operating position.

In carrying out the above object and other objects, an embodiment of the present invention provides a bicycle carrier for a vehicle. The bicycle carrier includes a base holder mountable to a vehicle, a support holder for holding a bicycle, and a fixing device. The base holder includes first and second guide rails which are spaced apart from one another and extend in a longitudinal direction of the vehicle. The support holder includes first and second support rails which are spaced apart from one another and extend in the longitudinal direction of the vehicle. The first support rail is movably engaged to the first guide rail and the second support rail is movably engaged to the second guide rail to movably connect the support holder to the base holder such that the support holder is movable between a neutral position in which the support holder extends over the base holder and an operating position in which the support holder extends from the base holder to hold a bicycle. The fixing device is operable for acting on the first support rail and the first guide rail to disrupt the movable engagement between the first support rail and the first guide rail. The fixing device is actuatable between an unlocked position in which the first support rail is movable relative to the first guide rail and a locked position in which the first support rail is locked in place relative to the first guide rail while the support holder is in the operating position to lock the support holder in the operating position.

Further, in carrying out the above objects and other objects, an embodiment of the present invention provides another bicycle carrier. This bicycle carrier includes first and second fixing devices in addition to the base holder and the support holder. The first fixing device is operable for acting on the first support rail and the first guide rail to disrupt the movable engagement between the first support rail and the first guide rail. The second fixing device is operable for acting on the second support rail and the second guide rail to disrupt the movable engagement between the second support rail and the second guide rail. Each fixing device is actuatable between an unlocked position in which the support rails are movable relative to the guide rails and a locked position in which the support rails are locked in place relative to the guide rails while the support holder is in the operating position to lock the support holder in the operating position.

A bicycle carrier in accordance with embodiments of the present invention includes a base holder and a support holder and a fixing device(s) which fixes the support holder to the base holder while the support holder is in the operating position to form a rigid bicycle carrier which properly absorbs stresses occurring during vehicle operation. In the operating position of the support holder, the support rails of the support holder project beyond the corresponding guide rails of the base holder, and the fixing devices clamp the base holder and the support holder to one another. Without the fixing devices, the support holder would move uncontrollably during vehicle operation. The locking system of each fixing device is between the corresponding support and guide rails. The first locking element, the second locking element, and the lifting device for the locking system are components that are easily implemented. The same applies to the bearing bolt and the rotatable rotary element. A targeted locked and unlocked position is achieved by the cam apparatus for the lifting device. Each fixing device, i.e., the rotary element, includes a hand lever by which the fixing device may be actuated in a user-friendly manner. The fact that the hand lever for moving the rotary element between a locked and an unlocked position describes an angle of approximately 90° and is held in position, at least in the unlocked position, by a catch device supports the functioning and convenience of the fixing device. Lastly, a visual identification of the hand lever in the unlocked and locked positions contributes to the convenience.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a perspective view of a rear end portion of a vehicle having a bicycle carrier in accordance with an embodiment of the present invention;

FIG. 2 illustrates a perspective view of the bicycle carrier with the support holder of the bicycle carrier in its operating position relative to the base holder of the bicycle carrier;

FIG. 3 illustrates a perspective view of the bicycle carrier with the support holder of the bicycle carrier in its neutral position relative to the base holder of the bicycle carrier;

FIG. 4 illustrates a cross-sectional view of one side of the bicycle carrier along the line IV-IV of FIG. 2;

FIG. 5 illustrates an enlarged cross-sectional view of a portion of the side of the bicycle carrier along the line V-V of FIG. 4;

FIG. 6 illustrates an enlarged cross-sectional view of the side of the bicycle carrier along the line VI-VI of FIG. 3; and

FIG. 7 illustrates an exploded view of a portion of the fixing device of the bicycle carrier.

### DETAILED DESCRIPTION OF THE PREFERRED EMBODIMENT(S)

Identical components have the same reference numerals in the figures.

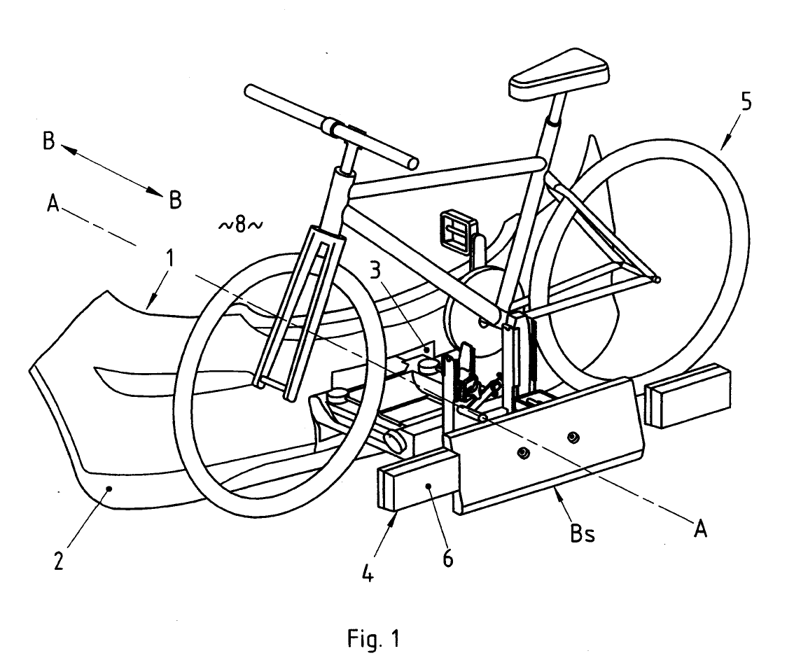

Referring now to FIG. 1, a perspective view of a rear end portion 2 of a vehicle 1 having a bicycle carrier 4 in accordance with an embodiment of the present invention is shown. Rear end vehicle portion 2 has an opening 5 running along a central longitudinal plane A-A of vehicle 1 for receiving an extension of carrier 4 in order for carrier 4 to be mounted to vehicle 1. Carrier 4 is intended for use with vehicle 1 to transport two upright bicycles side-by-side.

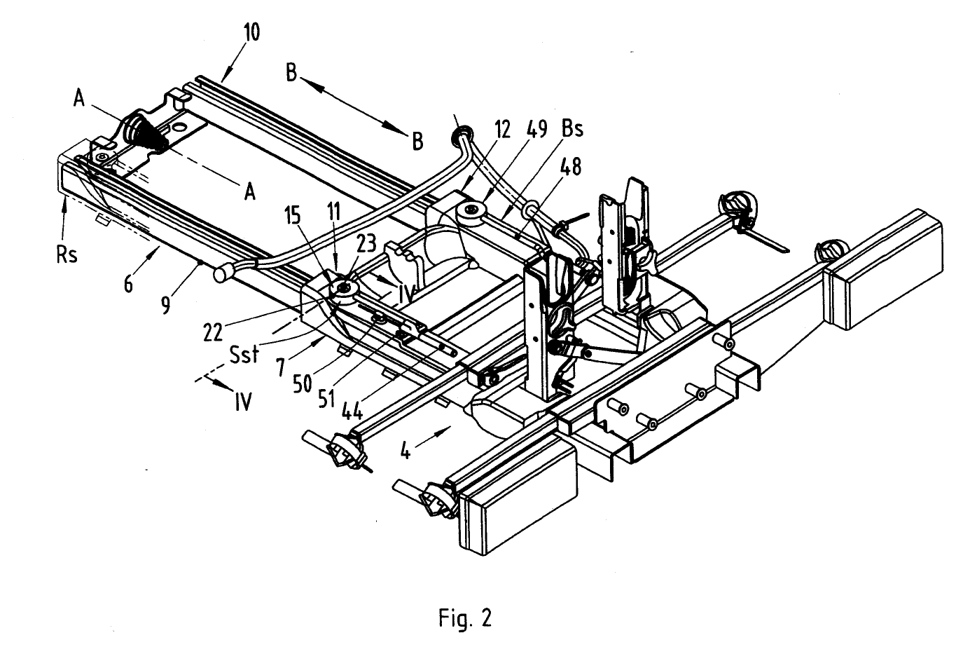

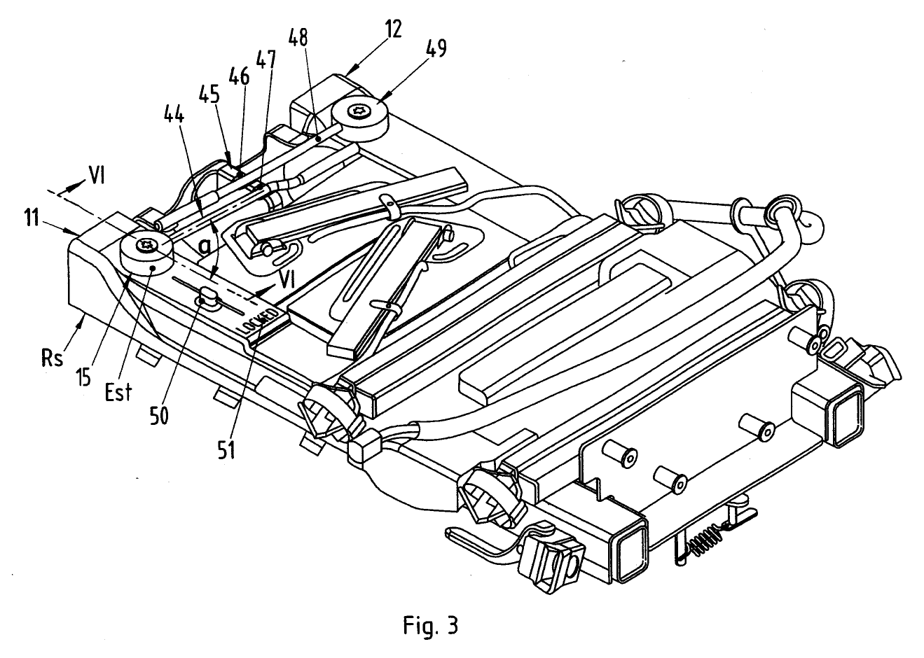

Referring now to FIGS. 2 and 3, with continual reference to FIG. 1, perspective views of carrier 4 are shown. Carrier 4 includes a base holder 6 and a support holder 7. Bicycles aligned transversely to longitudinal direction B-B of vehicle 1 may mount onto support holder 7. FIG. 1 illustrates a bicycle 5 mounted onto support holder 7 in this manner. Support holder 7 is movable relative to base holder 6 along longitudinal vehicle direction B-B between a neutral position Rs and an operating position Bs. In the neutral position Rs, support holder 7 is lowered and stored within a storage compartment 8 of vehicle 1. In the operating position Bs, support holder 7 extends out from rear end vehicle portion 2. FIGS. 1 and 2 illustrate support holder 7 in its operating position Bs relative to base holder 6. FIG. 3 illustrates support holder 7 in its neutral position Rs relative to base holder 6.

In order to enable support holder 7 to be movable relative to base holder 6, base holder 6 includes inner guide rails 8, 9 and support holder 7 includes corresponding outer guide rails 10, 11. Inner guide rails 8, 9 and outer guide rails 10, 11 are on respective sides of central longitudinal plane A-A. Outer guide rails 10, 11 cooperate with corresponding inner guide rails 8, 9 to move support holder 7 relative to base holder 6. Guide rails 9, 10 and support rails 11, 12 cooperate with one another with a form-fit connection.

Guide rails 9, 10 are structurally identical to one another and support rails 11, 12 are structurally identical to one another. Likewise, the functional interaction between guide rail 9 and support rail 11 and between guide rail 10 and support rail 12 is the same. As such, description below regarding guide rail 9 and support rail 11 also corresponds to guide rail 10 and support rail 12, respectively.

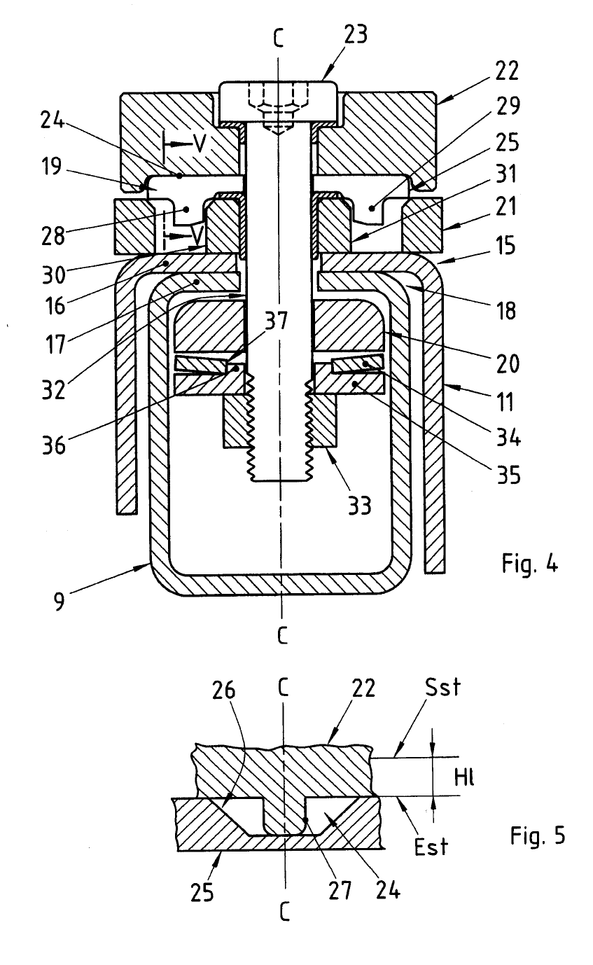

Referring now to FIG. 4, with continual reference to FIGS. 1, 2, and 3, a cross-sectional view of one side of carrier 4 along the line IV-IV of FIG. 2 is shown. Guide rail 9 includes a tubular body having a square cross-section. Support rail 11 has a U-shaped cross-section. Support rail 11 overlaps guide rail 9. In particular, a support wall 16 of support rail 11 rests on a guide wall 17 of guide rail 9. Support wall 16 and guide wall 17 are horizontally aligned with one another.

A fixing device 15 lies over guide rail 9 and support rail 11. Likewise, a second fixing device 49 lies over guide rail 10 and support rail 12. Fixing devices 15 and 49 are structurally identical to one another. As such, description below regarding fixing device 15 also corresponds to second fixing device 49.

Fixing device 15 is actuable between a locked position Sst (see FIG. 2) and an unlocked position Est (see FIG. 3). A hand lever 44 is rotatably connected to fixing device 15 for moving fixing device 15 between its locked position Sst and its unlocked position Est. In the locked position Sst of fixing device 15, hand lever 44 extends over guide rail 9 and is parallel to guide rail 9 and support rail 11. In the unlocked position Est of fixing device 15, hand lever 44 extends toward guide rail 10 and support rail 12 and is perpendicular to guide rail 9 and support rail 11.

Fixing device 15 fixes support rail 11 to guide rail 9 when fixing device 15 is in its locked position Sst while support holder 7 is in its operating position Bs to lock support holder 7 in its operating position Bs. Likewise, fixing device 15 may fix support rail 11 to guide rail 9 when fixing device 15 is in its unlocked position Est while support holder 7 is in its neutral position Rs to lock support holder 7 in its neutral position Rs.

Fixing device 15 includes a locking system 18 for fixing support rail 11 to guide rail 9. Locking system 18 acts between support wall 16 of support rail 11 and guide wall 17 of guide rail 9. Locking system 18 includes a lifting device 19, a first lower locking member 20, and a second upper locking member 21. First locking member 20 cooperates with guide wall 17 of guide rail 9. Second locking member 21 cooperates with support wall 16 of support rail 11.

With reference to FIG. 5, which illustrates an enlarged cross-sectional view of a portion of the side of carrier 4 along the line V-V of FIG. 4, lifting device 19 includes a rotary element 22. Rotary element 22 is rotatable about a bearing bolt 23 of fixing device 15. Bearing bolt 23 holds rotary element 22, lifting device 19, and second locking member 21 in position and holds first locking member 20 in position. Rotary element 22 is rotated about a rotational axis C-C of bearing bolt 23 to move fixing device 15 between its locked position Sst and its unlocked position Est.

Lifting device 19 further includes a cam apparatus 24. Cam apparatus 24 acts between rotary element 22 and second locking member 21. Cam apparatus 24 includes a washer 25 having an integrated cam track 26 therein. Rotary element 22 includes a cam 27 in the shape of a cylindrical body facing cam track 26. Cam 27 slides along cam track 26 upon rotation of rotary element 22 about a rotational axis C-C of bearing bolt 23 and is guided between the unlocked position Est and the locked position Sst of fixing device 15. During rotational motion of rotary element 22, cam 27 axially undergoes a lifting motion of lift length H1. Washer 25 of cam apparatus 24 is fastened to second locking member 21. For this purpose, fixing pins 28, 29 on washer 25 project into corresponding recesses 30, 31 of second locking member 21.

A shaft 32 of bearing bolt 23 passes through support wall 16 of support rail 22 and guide wall 17 of guide rail 9. A screw nut 33 is attached to the end of shaft 32 facing away from rotary element 22. Screw nut 33 axially secures first locking member 20. A spring element in the form of a disk spring 34 is between first locking member 20 and screw nut 33. A support disk 35 is inserted between disk spring 34 and screw nut 33. A pin-like projection 36 of support disk 35 protrudes into a borehole 37 in disk spring 34.

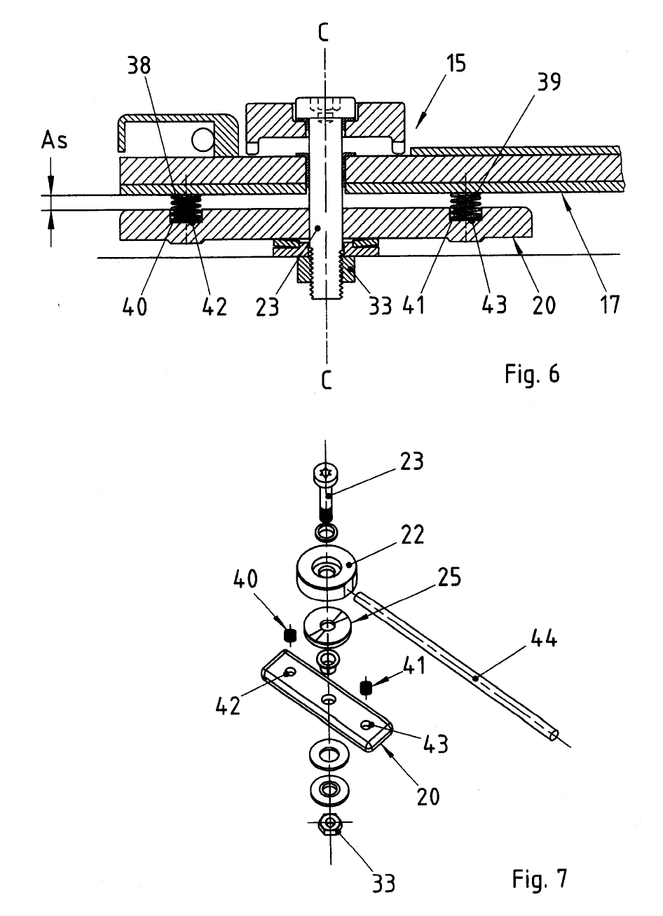

With reference to FIG. 6, which illustrates an enlarged cross-sectional view of the side of carrier 4 along the line VI-VI of FIG. 3, and with reference to FIG. 7, which illustrates an exploded view of a portion of fixing device 15. As shown, locking member 20 of fixing device 15 has a plate-like form and includes support members 38, 39 on both sides of bearing bolt 23. Support member 38, 39 are raised toward guide wall 17 of guide rail 9 such that a distance As is between first locking member 20 and guide wall 17. Distance As approximately corresponds to the lift length H1. Support members 38, 39 are compression springs 40, 41 which are guided in first locking member 20 via respective boreholes 42, 43.

For moving fixing device 15 between its locked position Sst and its unlocked position Est, hand lever 44 extends radially with respect to rotary element 22 and is rotatably connected thereto. Again, FIG. 2 illustrates fixing device 15 in its locked position Sst and FIG. 3 illustrates fixing device 15 in its unlocked position Est. Hand lever 44 is rod shaped and has a defined elasticity as viewed in the longitudinal direction. Hand lever 44 defines an angle α of approximately 90° when being rotated to move rotary element 22 between the locked position Sst of fixing device 15 and the unlocked position Est of fixing device 15. In the unlocked position Est of fixing device 15, a recess 46 of hand lever 44 cooperates with a catch device 45 mounted on support holder 7 to fix hand lever 44 in place.

Similarly, for moving second fixing device 49 which is associated with guide rail 10 of base holder 6 and support rail 12 of support holder 7 between its locked position Sst and its unlocked position Est, a second hand lever 48 extends radially with respect to the rotary element of second fixing device 49 and is rotatably connected thereto. Second hand lever 48 is also rod shaped and has a defined elasticity as viewed in the longitudinal direction. Second hand lever 48 defines an angle α of approximately 90° when being rotated to move the rotary element of second fixing device 49 between locked position Sst and unlocked position Est. In the unlocked position Est, a recess 47 of second hand lever 48 cooperates with catch device to fix second hand lever 44 in place.

Because hand levers 44, 48 are elastic hand levers 44, 48 may engage in and disengage from recesses 46, 47 by slight manual deformations. A stop 50 is mounted on the top side of support rail 11 for supporting hand lever 44 in the locked position Sst. Likewise, a stop is mounted on the top side of support rail 12 for supporting hand lever 48 in the locked position.

Support holder 7 includes visual identification for hand lever 44 at least in the locked position Sst. The visual identification may be a label such as “LOCKED” or the like. Likewise, support holder 7 includes visual identification for hand lever 48 at least in the locked position Sst.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A bicycle carrier for a vehicle, the carrier comprising:
a base holder mountable to a vehicle, wherein the base holder includes first and second guide rails which are spaced apart from one another and extend in a longitudinal direction of the vehicle;
a support holder for holding a bicycle, wherein the support holder includes first and second support rails which are spaced apart from one another and extend in the longitudinal direction of the vehicle;
wherein the first support rail is movably engaged to the first guide rail and the second support rail is movably engaged to the second guide rail to movably connect the support holder to the base holder such that the support holder is movable between a neutral position in which the support holder extends over the base holder and an operating position in which the support holder extends from the base holder to hold a bicycle; and
a fixing device operable for acting on the first support rail and the first guide rail to disrupt the movable engagement between the first support rail and the first guide rail, wherein the fixing device is actuatable between an unlocked position in which the first support rail is movable relative to the first guide rail and a locked position in which the first support rail is locked in place relative to the first guide rail while the support holder is in the operating position to lock the support holder in the operating position.

2. The carrier of claim 1 wherein:
the fixing device includes a locking system;
wherein the first guide rail includes a guide wall and the first support rail includes a support wall, wherein the support wall of the first support rail is movably engaged to the guide wall of the first guide rail;
wherein the locking system is operable for acting on the support wall of the first support rail and the guide wall of the first guide rail to disrupt the movable engagement between the first support rail and the first guide rail.

3. The carrier of claim 2 wherein:
the locking system includes a lifting device, a first locking member, and a second locking member.

4. The carrier of claim 3 wherein:
the first locking member cooperates with the guide wall of the first guide rail and the second locking member cooperates with the support wall of the first support rail.

5. The carrier of claim 3 wherein:
the lifting device has a rotary element rotatably movable about a bearing bolt passing through the support wall of the first support rail and the guide wall of the first guide rail.

6. The carrier of claim 5 wherein:
the bearing bolt holds the rotary element, the lifting device, the first locking member, and the second locking member in position.

7. The carrier of claim 6 wherein:
the lifting device includes a cam apparatus which acts between the rotary element and the second locking member.

8. The carrier of claim 7 wherein:
the cam apparatus has a washer attached to the second locking member.

9. The carrier of claim 8 wherein:
the washer projects into corresponding recesses in the second locking member by fixing pins.

10. The carrier of claim 5 wherein:
the bearing bolt includes a screw nut on its side facing away from the rotary element, wherein the screw nut secures the first locking member to the guide wall of the first guide rail.

11. The carrier of claim 10 wherein:
a spring is between the first locking member and the screw nut).

12. The carrier of claim 11 wherein:
the spring is a disk spring, wherein a support disk is inserted between the disk spring and the screw nut.

13. The carrier of claim 5 wherein:
the first locking member has support members on both sides of the bearing bolt, wherein the support members are raised toward the guide wall of the first guide rail.

14. The carrier of claim 13 wherein:
the support members act as springs.

15. The carrier of claim 5 wherein:
the fixing device includes a hand lever for actuating the fixing device between the unlocked position and the locked position.

16. The carrier of claim 15 wherein:
the hand lever is fixedly connected to the rotary element.

17. The carrier of claim 16 wherein:
the hand lever describes an angle of approximately 90° for moving the rotary element between the locked position and the unlocked position of the fixing device.

18. The carrier of claim 17 wherein:
the hand lever is held in position by a catch device of the support holder while the fixing device is in the unlocked position.

19. The carrier of claim 15 wherein:
the support holder includes visual identification for the hand lever at least in the locked position of the fixing device.

20. A bicycle carrier for a vehicle, the carrier comprising:
a base holder mountable to a vehicle, wherein the base holder includes first and second guide rails which are spaced apart from one another and extend in a longitudinal direction of the vehicle;
a support holder for holding a bicycle, wherein the support holder includes first and second support rails which are spaced apart from one another and extend in the longitudinal direction of the vehicle;
wherein the first support rail is movably engaged to the first guide rail and the second support rail is movably engaged to the second guide rail to movably connect the support holder to the base holder such that the support holder is movable between a neutral position in which the support holder extends over the base holder and an operating position in which the support holder extends from the base holder to hold a bicycle;
a first fixing device operable for acting on the first support rail and the first guide rail to disrupt the movable engagement between the first support rail and the first guide rail; and
a second fixing device operable for acting on the second support rail and the second guide rail to disrupt the movable engagement between the second support rail and the second guide rail;
wherein each fixing device is actuatable between an unlocked position in which the support rails are movable relative to the guide rails and a locked position in which the support rails are locked in place relative to the guide rails while the support holder is in the operating position to lock the support holder in the operating position.
